(19) United States
(12) Patent Application Publication
(10) Pub. No.: US 2011/0225978 A1
(43) Pub. Date: Sep. 22, 2011

(54) TURBOMACHINE DRIVE ARRANGEMENT

(76) Inventors: David S. Behling, Belvidere, IL (US); Glenn C. Lemmers, JR., Loves Park, IL (US)

(21) Appl. No.: 12/785,532

(22) Filed: May 24, 2010

Related U.S. Application Data
(60) Provisional application No. 61/340,418, filed on Mar. 17, 2010.

(51) Int. Cl. F02C 7/27; H02K 23/52

(52) U.S. Cl. 60/788; 290/46

(57) ABSTRACT

An example arrangement for driving a turbomachine includes an input shaft that is configured to rotate a rotor of the turbomachine through a hydraulic log and gear differential rotatable coupled to the input shaft. A motor-generator is rotatably coupled to the differential. The motor-generator has a motor mode of operation and a generator mode of operation. The motor-generator is configured to drive the input shaft through the hydraulic log and differential when the motor-generator is in the motor mode of operation. The input shaft is configured to drive the motor-generator through the hydraulic log and differential when the motor-generator is in the generator mode of operation.

### CROSS-REFERENCE TO RELATED APPLICATIONS

This disclosure claims priority to U.S. Provisional Application No. 61/340,418, which was filed on 17 Mar. 2010 and is incorporated herein by reference.

### BACKGROUND

This disclosure relates generally to a drive arrangement for a turbomachine. More particularly, this disclosure relates to an arrangement that drives the turbomachine during a first mode of operation and generates electric power using the turbomachine in a second mode of operation.

Turbomachines, such as gas turbine engines are known. A typical turbomachine includes multiple sections, such as a fan section, a compression section, a combustor section, and a turbine section. Many turbomachines, particularly gas turbine engines, have large rotors in the compression section that must be accelerated to high rotational speeds until the rotor is rotating fast enough to sustain operation of the turbomachine. Typically, a motor separate from the turbomachine drives an input shaft that is used to accelerate the rotors.

Many turbomachines use generators to produce electric power for various components, such as components on an aircraft. Some turbomachines use generators separate from the motor that drives the rotors. Integrated drive generators (IDGs) are an example of this type of generator, which can produce constant frequency electric power. As can be appreciated, the generator separate from the motor undesirably adds weight and complexity to the turbomachine.

Other turbomachines use the motors as generators after the turbomachine is self-sustaining. The turbomachine drives these generators. A variable frequency starter generator (VFSG) is an example of this type of generator. VFSGs generate electric output power with a frequency that is proportional to the turbomachine speed. Electrical usage equipment must then be capable of operating under this variable frequency input, which generally increases their weight, envelope, power losses, and cost. Some arrangements of this type include complicated shafting, gearing, clutching, or valving to enable both start and generate modes of operation.

### SUMMARY

An example turbomachine arrangement includes a driveshaft that is configured to drive the input shaft of an integrated drive generator (IDG). The IDG includes a hydraulic variator (log) and gear differential rotatably coupled to the input shaft. A motor-generator is rotatably coupled to the differential. The motor-generator has a motor mode of operation and a generator mode of operation. The motor-generator is configured to drive the IDG input shaft through the differential and hydraulic log when the motor-generator is in the motor mode of operation. The input shaft is configured to drive the motor-generator through the differential and hydraulic log when the motor-generator is in the generator mode of operation.

An example gas turbine engine arrangement includes a motor-generator and a compressor rotor. A hydraulic log and differential are configured to adjust a rotational input from the motor-generator or the compressor rotor. The hydraulic log provides the rotational output to the motor-generator or the compressor rotor depending on the mode of operation.

A method of driving components within a turbomachine includes providing a first rotational input to a hydraulic log and differential using a motor-generator when the motor-generator is in a motor mode of operation. The method uses the hydraulic log to adjust the first rotational input and to provide a second rotational input that drives a compressor rotor. The method provides a third rotational input to the hydraulic log using the compressor rotor when the motor-generator is in a generator mode of operation. The method uses the hydraulic log to adjust the third rotational input and to provide a fourth rotational input that drives the motor-generator.

These and other features of the disclosed examples can be best understood from the following specification and drawings, the following of which is a brief description:

### BRIEF DESCRIPTION OF THE DRAWINGS

FIG. 1 shows a section view of an example gas turbine engine.

FIG. 2 shows an example rotor assembly of the FIG. 1 engine.

FIG. 3 shows a highly schematic view of an arrangement for driving the FIG. 1 engine.

FIG. 4 shows a more detailed view of the FIG. 3 arrangement.

FIG. 5 shows a close-up schematic view of a wobbler plate within the FIG. 4 hydraulic log.

### DETAILED DESCRIPTION

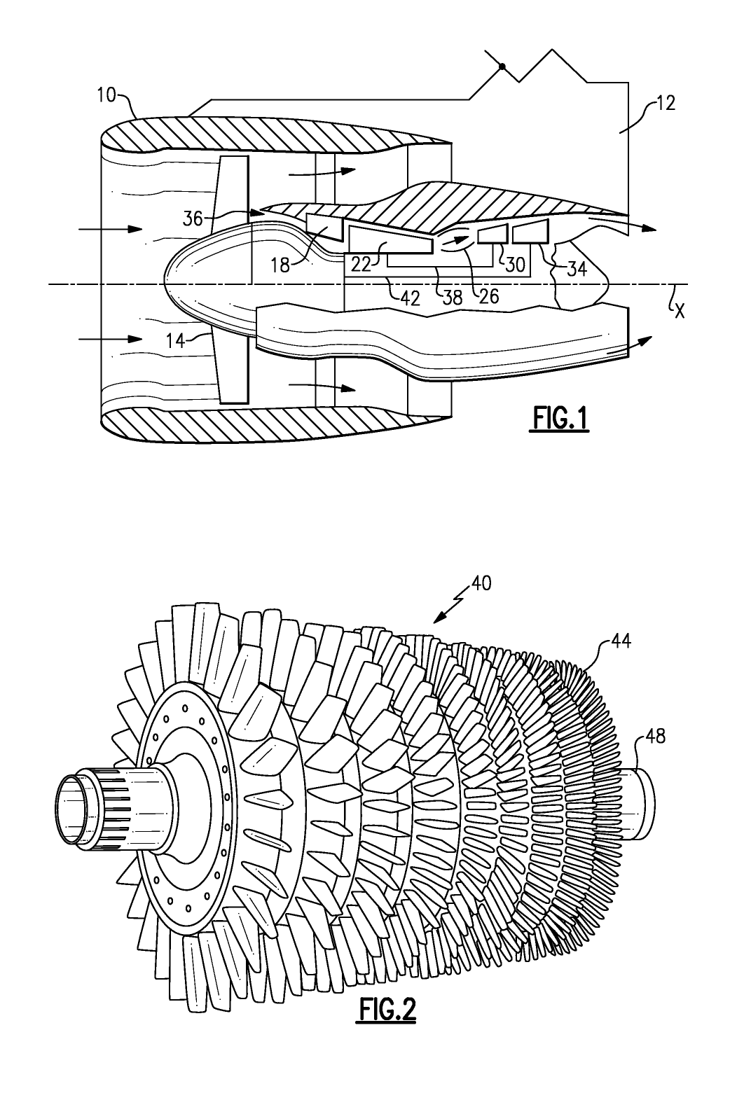

Referring to FIGS. 1 and 2, an example gas turbine engine 10 is used to propel an aircraft 12. The gas turbine engine 10 is an example type of turbomachine.

The example gas turbine engine 10 includes (in serial flow communication) a fan section 14, a low pressure compressor 18, a high pressure compressor 22, a combustor 26, a high pressure compressor 22, a combustor 26, a high pressure turbine 30, and a low pressure turbine 34. The gas turbine engine 10 is circumferentially disposed about an engine axis X.

During operation, air is pulled into the gas turbine engine 10 by the fan section 14. Some of the air moves through a flow path 36 to a core of the gas turbine engine 10. The air moving through the flow path 36 is pressurized by the compressors 18 and 22, mixed with fuel, and burned within the combustor 26. The turbines 30 and 34 extract energy from the hot combustion gases flowing from the combustor 26.

In a two spool design, the high pressure turbine 30 utilizes the extracted energy from the hot combustion gases to power the high pressure compressor 22 through a high speed shaft 38, and the low pressure turbine 34 utilizes the extracted energy from the hot combustion gases to power the low pressure compressor 18 and the fan section 14 through a low speed shaft 42.

The examples described in this disclosure are not limited to the two spool engine architecture described, however, and may be used in other architectures, such as single spool axial design, a three spool axial design, and still other architectures. Further, although the examples described herein are described with regard to the gas turbine engine 10, those having skill in this art and the benefit of this disclosure will understand that other examples include other types of turbomachines.

As known, the compressor sections 18 and 22 include a rotor assembly 40 having blades 44 connected to a shaft 46. Rotating the shaft 46 rotates the rotor blades. The rotor blades 44, when rotated, compress the air moving through the flow path 36.

The rotor assembly 40 rotates to compress air within the compressor sections 18 and 22 during start-up of the engine 10. A motor-generator 54 continues to drive rotation of the rotor assembly 40 until the rotor assembly 40 reaches a speed capable of compressing enough air to sustain operation of the engine 10. Once the engine 10 is self-sustaining, the turbines 30 and 34 are able to suitably drive the rotor assembly 40 without requiring the rotational input from the motor-generator 54. In this example, the motor-generator 54 operates as a generator after the engine 10 has reached self-sustaining speed.

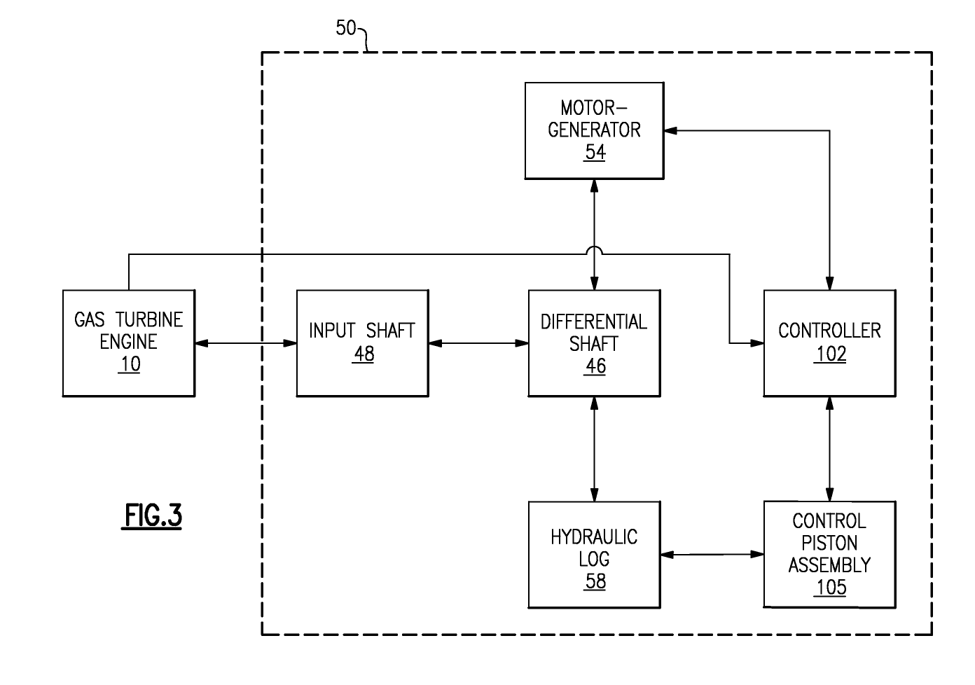

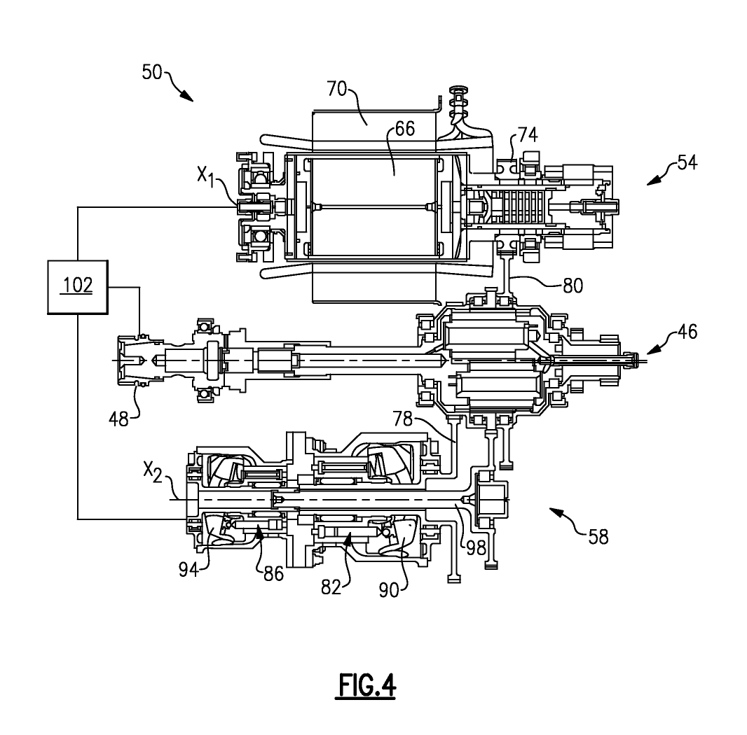

Referring to FIG. 3, an arrangement 50 for driving the engine 10 of FIG. 1 includes the motor-generator 54, a hydraulic log 58, and a gear differential 46. The motor-generator 54 provides the rotational input to the hydraulic log 58 and differential 46 during start-up of the engine 10.

Once the engine 10 is self-sustaining, the engine 10 is configured to rotate the arrangement's input shaft 48, rather than the input shaft 48 rotating portions of the engine 10. When the engine 10 rotates the input shaft 48, the hydraulic log 58 is configured to provide a rotational input to the differential 46. The differential 46 then provides a rotational input to the motor-generator 54 so that the motor-generator 54 can operate as a generator and provide power in a known manner. The aircraft 12 utilizes power from the motor-generator 54 to operate various devices on the aircraft 12.

As can be appreciated, a relatively consistent supply of power from the motor-generator 54 is required. Variations in the rotational speed of the input shaft 48 would vary the power output from the motor-generator 54 were it not for the hydraulic log 58. The hydraulic log 58, in this example, accommodates the varying rotational speeds of the input shaft 48 and provides the motor-generator 54 with a relatively consistent rotational input such that the motor-generator 54 is able to provide a relatively consistent frequency source of power to the aircraft 12.

In one example, the hydraulic log 58 receives the rotational input from the motor-generator 54 during start-up of the engine 10. The hydraulic log 58 then provides a rotational output to the input shaft 48. The hydraulic log 58 adjusts the rotational input to a rotational output suitable for driving the engine 10. A person having skill in this art would understand a rotational output suitable for driving the input shaft 48 during start up of the engine 10.

The hydraulic log 58 accommodates variability in the rotational output provided by the motor-generator 54 during motor mode and the rotational input provided by the engine 10 during generator mode.

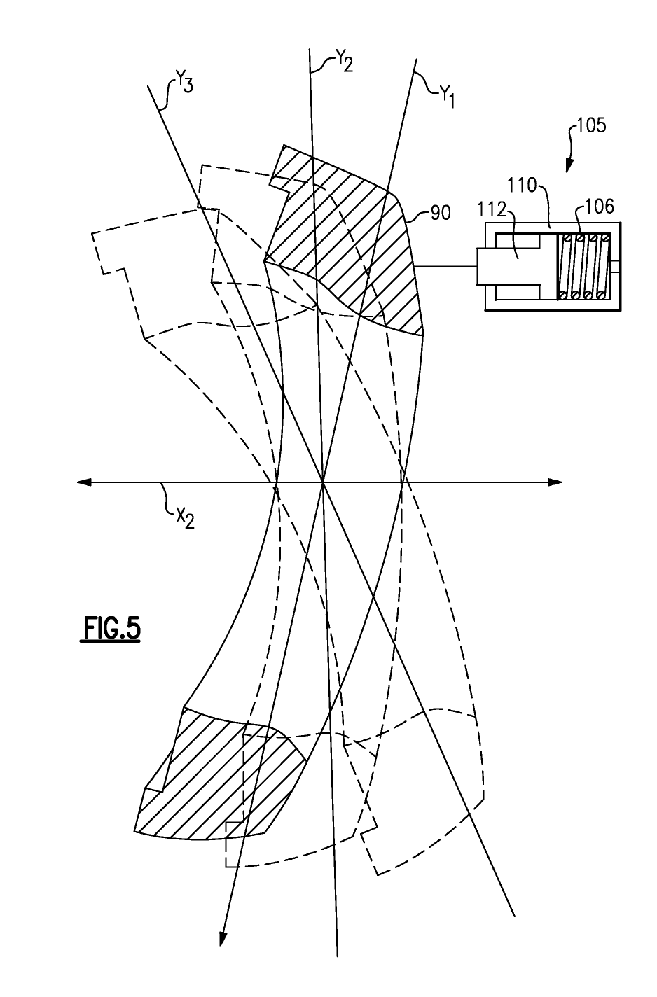

Referring now to FIG. 4 with continuing reference to FIG. 3, the motor-generator 54 in the example arrangement 50 includes a rotor 66 and stator 70 arranged about a motor centerline X₁. The motor-generator 54 rotates a gear 74 that is rotatably coupled to the differential 46.

The hydraulic log 58 includes a first plurality of pistons 82 and a second plurality of pistons 86. A wobbler plate 90 controls the stroke length of the first plurality of pistons 82. The wobbler plate 90 is adjusted relative to an axis X₂ of the hydraulic log 58 to change the stroke lengths of the plurality of pistons 82. A wobbler plate 94 controls the stroke lengths of the second plurality of pistons 86. The wobbler plate 94 is adjusted relative to the axis X₂ of the hydraulic log 58 to change the stroke lengths of the second plurality of pistons 86.

When the gas turbine engine 10 is driving the arrangement 50 to produce electric power in generate mode, adjusting the strokes of the first plurality of pistons 82 and the second plurality of pistons 86 adjusts the rotation of a gear 78 relative to the rotation of the hydraulic log shaft 98. The hydraulic log 58 is thus able to step up or step down rotation of gear 78 relative to the input shaft 48 speed by varying the positions of the wobbler plates 90 and 94. The gear differential 46 sums the speed of gear 78 and the speed of the input shaft 48 and produces a resultant output speed on gear 80 to drive the motor-generator 54. The relationship between the speed of gear 78, the speed of input shaft 48, and the speed of gear 80 is constant and is determined by the relative number of teeth on the gears within the differential 46. Proper control of gear 78 speed relative to the input shaft 48 speed produces a constant speed on gear 80 and on the motor-generator 54. Constant speed on the motor-generator 54 produces a constant frequency electric power output from the arrangement 50.

In this example, a controller 102 controls the positions of wobbler plates 90 and 94 via a control piston assembly 105 connected to each wobbler plate. For example, if the gear 74 is rotating too fast to supply constant frequency power from the motor-generator 54, the controller 102 initiates an adjustment to at least one of the wobbler plates 90 or 94 that causes gear 78 to slow its rotation. As can be appreciated, slowing the rotation of gear 78 slows rotation of gear 74 thru the gear differential 46.

Referring now to FIG. 5 with continuing reference to FIG. 4, the wobbler plates 90 and 94 are connected to individual control piston assemblies 105 to enable movement over the range bounded by lines Y₁ and Y₃. The controller 102 varies the position of the wobbler plates 90 and 94 by varying the hydraulic pressure acting on the control pressure side of the piston 110. The control piston assemblies 105 include biasing forces in the form of spring and hydraulic pressure. The hydraulic pressure bias in the control piston assembly 105 for wobbler plate 90 is connected to the working pressure generated by the plurality of pistons 82 and 86. A person having skill in this art would understand how to bias the control piston assemblies 105 using a spring 106 and a piston 112, or hydraulic pressure.

During start-up of the gas turbine engine 10, the stator 70 of the motor-generator 54 is connected to an external electric power source. The external power source causes the motor-generator 54 to act as an electric motor and accelerates the rotor 66. During acceleration of the rotor 66, the controller 102 initiates an adjustment to at least one of the wobbler plates 90 or 94 that allows the rotor 66 to accelerate while the input shaft 48 is stationary. In this mode, the hydraulic log 58 essentially free-wheels and provides minimal resistance to the motor-generator 54. This allows the rotor 66 to be accelerated with minimal drag torque and essentially declutches the rotor 66 from the input shaft 48 during initial acceleration. A person having skill in this art would understand how this would allow significant size and weight savings for both the motor-generator 54 and the external electric power source.

Once the rotor 66 is accelerated to synchronous speed, it is available to provide significant torque to the input shaft 48 to start the gas turbine engine 10. At this point, the controller 102 initiates adjustments to wobbler plate 90 to cause this half of the hydraulic log 58 to function as a hydraulic pump. The spring and bias pressure in the control piston assembly 105 connected to wobbler plate 94 cause this half of the hydraulic log 58 to function as a hydraulic motor in response to the working pressure generated by the plurality of pistons 82. Since the plurality of pistons 86 are stationary at the start of this sequence, working pressure rises as the plurality of pistons 82 pump oil against them.

The mechanical torque produced by the plurality of pistons 86 is transmitted via gear shaft 98 to the differential 48. The gradual addition of torque to the differential 46 causes the input shaft 48 to accelerate and gear 78 to decelerate. Acceleration of input shaft 48 causes the gas turbine engine 10 to accelerate. During acceleration, the hydraulic pressure bias in the control piston assembly 105 for wobbler plate 90 maintains the working pressure in hydraulic log 58 to a level suitable for acceleration of the gas turbine engine 10. Essentially, the portion of the hydraulic log 58 having the wobbler plate 90 operates as a pressure compensated pump during acceleration of the gas turbine engine 10. The torque on the input shaft 48 peaks when the portion of the hydraulic log with wobbler plate 90 reaches maximum displacement, for example. The remainder of the start cycle is then maintained at a constant power by limiting current to the motor-generator 54.

As the example gas turbine engine 10 reaches self-sustaining operation, the controller 102 initiates adjustments to wobbler plate 90 which cause that half of the hydraulic log 58 to transition to a hydraulic motor. Simultaneously, the controller 102 initiates adjustments to wobbler plate 94 which cause that half of the hydraulic log 58 to transition to a hydraulic pump. Essentially, the two halves of the hydraulic log 58 switch roles as they transition from start mode to generate mode.

Once in generate mode, wobbler plate 90 is held in a position aligned with line Y₁ by the hydraulic bias pressure within control piston assembly 105. In generate mode, controller 102 senses output frequency of the motor-generator 54 and varies the control pressure acting on the control piston assembly 105 to adjust the position of wobbler plate 94 as necessary to maintain a consistent speed of the motor-generator 54.

In one example, the controller 102 senses current to the motor-generator 54 to regulate movement of the wobbler plates 90 and 94 during the transition from start to generate mode. If the wobblers 90 and 94 are repositioned too fast, the motor-generator 54 current may undesirably climb. Further, if the wobbler plates 90 and 94 are repositioned too slow, the gas turbine engine 10 start could stall. A person skilled in this art could establish a proper relationship between the decay of current to the motor-generator 54 and the working pressure in the hydraulic log 58.

In this example, the position of the wobbler plate 90 when aligned with the line Y₂ corresponds to a motor-generator 54 acceleration mode of operation. The position of the wobbler plate 90 when aligned with line Y₁ corresponds to a normal generator mode of operation. The position of wobbler plate 90 when between line Y₂ and Y₃ corresponds to a start mode of operation during which the gas turbine engine 10 is being accelerated.

Features of the disclosed examples include using a motor-generator to start an engine and to provide electric power to the engine during different modes of operation. Another feature includes a lower weight and lower cost design when compared to other motor-generator options.

Although an example embodiment has been disclosed, a worker of ordinary skill in this art would recognize that certain modifications would come within the scope of the claims. For that reason, the following claims should be studied to determine their true scope and content.

We claim:

1) An arrangement for driving a turbomachine, comprising:
an input shaft that is configured to rotate a turbomachine rotor;
a hydraulic log assembly rotatably coupled to the input shaft; and
a motor-generator rotatably coupled to the hydraulic log assembly, the motor-generator having a motor mode of operation and a generator mode of operation, wherein the motor-generator is configured to drive the input shaft through the hydraulic log assembly when the motor-generator is in the motor mode of operation, and the input shaft is configured to drive the motor-generator through the hydraulic log assembly when the motor-generator is in the generator mode of operation.

2) The arrangement of claim 1, wherein the hydraulic log assembly is configured to adjust the rotational input from the motor-generator to drive the input shaft when the motor-generator is in the motor mode of operation.

3) The arrangement of claim 1, wherein the hydraulic log assembly is configured to adjust the rotational input from the input shaft to provide a rotational output that drives the motor-generator when the motor-generator is in the generator mode of operation.

4) The arrangement of claim 1, including a first plurality of pistons and a second plurality of pistons within the hydraulic log assembly, wherein a stroke of the first plurality of pistons is configured to be adjusted with a first wobbler plate and a stroke of the second plurality of pistons is configured to be adjusted with a second wobbler plate.

5) The arrangement of claim 4, wherein the first wobbler plate selectively adjusts the stroke of the first plurality of pistons to provide a rotational output from the hydraulic log assembly that is different than a rotational input to the hydraulic log provided by the motor-generator.

6) The arrangement of claim 4, wherein the second wobbler plate selectively adjusts the stroke of the second plurality of pistons to provide a rotational output from the hydraulic log that is different than a rotational input to the hydraulic log provided by the input shaft.

7) The arrangement of claim 1, wherein the hydraulic log assembly comprises a differential.

8) A gas turbine engine arrangement, comprising:
a motor-generator;
a compressor rotor; and
a hydraulic log configured to adjust a rotational input from one of the motor-generator or the compressor rotor, and to provide a rotational output to the other of the motor-generator or the compressor rotor.

9) The gas turbine engine of claim 8, wherein the hydraulic log comprises a first plurality of pistons and a second plurality of pistons, the first plurality of pistons configured to selectively adjust a rotation input from one of the motor-generator or the compressor rotor, and the second plurality of pistons configured to selectively adjust a rotational input from the other of the motor-generator or the compressor rotor.

10) The gas turbine engine of claim 9, including a first wobbler plate configured to adjust the first plurality of pistons and a second wobbler plate configured to adjust the second plurality of pistons.

11) The gas turbine engine of claim 10, including control piston assemblies configured to adjust the position of the first and second wobbler plates.

12) The gas turbine engine of claim 11, wherein the control piston assemblies are controlled by hydraulic pressure and spring biasing.

13) The gas turbine engine of claim 12, including a controller configured to adjust the hydraulic pressure biasing of the control piston assemblies.

14) The gas turbine engine of claim 8, wherein the motor-generator is configured to provide a first rotational input to the hydraulic log, and the hydraulic log is configured to adjust the first rotational input to provide a second rotational input to the compressor rotor.

15) The gas turbine engine of claim 12, wherein the compressor rotor is configured to be driven by the rotational input provided by the hydraulic log until the engine reaches self-sustaining operation.

16) A method of driving components within a turbomachine, comprising:
providing a first rotational input to a hydraulic log using a motor-generator when the motor-generator is in a motor mode of operation;
adjusting the first rotational input to provide a second rotational input that drives a compressor rotor;
providing a third rotational input to the hydraulic log using the compressor rotor when the motor-generator is in a generator mode of operation; and
adjusting the third rotational input and to provide a fourth rotational input that drives the motor-generator.

17) The method of claim 16, including using a hydraulic log to perform the adjusting.

18) The method of claim 17, wherein the hydraulic log comprises more than one wobbler plate.

19) The method of claim 17, wherein the hydraulic log comprises a first plurality of pistons adjusted by a first wobbler plate and a second plurality of pistons adjusted by a second wobbler plate.

20) The method of claim 17, including spring-biasing at least one of the first wobbler plate or the second wobbler plate.

21) The method of claim 19, wherein the adjusting comprises tilting at least one of the first wobbler plate and the second wobbler plate relative a rotational axis of the hydraulic log.
